(19) United States
(12) Patent Application Publication
(10) Pub. No.: US 2004/0046053 A1
(43) Pub. Date: Mar. 11, 2004

(54) Aroma mist spraying device

(76) Inventor: Hung-Chih Chen, Miaoli (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/227,854

(22) Filed: Aug. 27, 2002

(51) Int. Cl. B05B 7/10

(52) U.S. Cl. 239/406

(57) ABSTRACT

An aroma mist spraying device includes a container, an air pipe, an air supply motor, and an aroma supply pipe. A high speed air flow produced by the air supply motor may be injected from the air pipe toward the aroma supply pipe, thereby sucking the aroma into the container, and thereby forming a misting effect.

### BACKGROUND OF THE INVENTION

1. Field of the Invention

The present invention relates to an aroma mist spraying device, and more particularly to an aroma mist spraying device, wherein the high speed air flow produced by the air supply motor may be injected from the air pipe toward the aroma supply pipe, thereby sucking the aroma into the container, and thereby forming a misting effect.

2. Description of the Related Art

A conventional aroma seat is provided with a candle or an alcohol lamp that may be burned to heat the aroma contained in the aroma seat, thereby spreading the fragrance of the aroma. However, if the candle or the alcohol lamp is upset, it easily burns other article, thereby causing danger. In addition, the aroma is easily volatilized during the heating process, so that it is necessary to add and replenish the aroma frequently, thereby causing inconvenience to the user.

### SUMMARY OF THE INVENTION

The primary objective of the present invention is to provide an aroma mist spraying device, wherein the high speed air flow produced by the air supply motor may be injected from the air pipe toward the aroma supply pipe, thereby sucking the aroma into the container, and thereby forming a misting effect.

In accordance with the present invention, there is provided an aroma mist spraying device, comprising:

a container;

an air pipe connected to the container;

an air supply motor for supplying air through the air pipe into the container; and

an aroma supply pipe connected to the container for supplying an aroma into the container; wherein:

the aroma is pushed upward through the aroma supply pipe into the container according to a syphon principle; and

the aroma supplied from the aroma supply pipe into the container is misted by an accelerated air flow from the air pipe according to a Bernoulli's principle.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an aroma mist spraying device in accordance with a first embodiment of the present invention;

FIG. 2 is a side plan cross-sectional view of the aroma mist spraying device as shown in FIG. 1;

FIG. 3 is a side plan cross-sectional view of the aroma mist spraying device in accordance with a second embodiment of the present invention;

FIG. 4 is a side plan cross-sectional view of the aroma mist spraying device in accordance with a third embodiment of the present invention; and

FIG. 5 is a side plan cross-sectional view of the aroma mist spraying device in accordance with a fourth embodiment of the present invention.

### DETAILED DESCRIPTION OF THE INVENTION

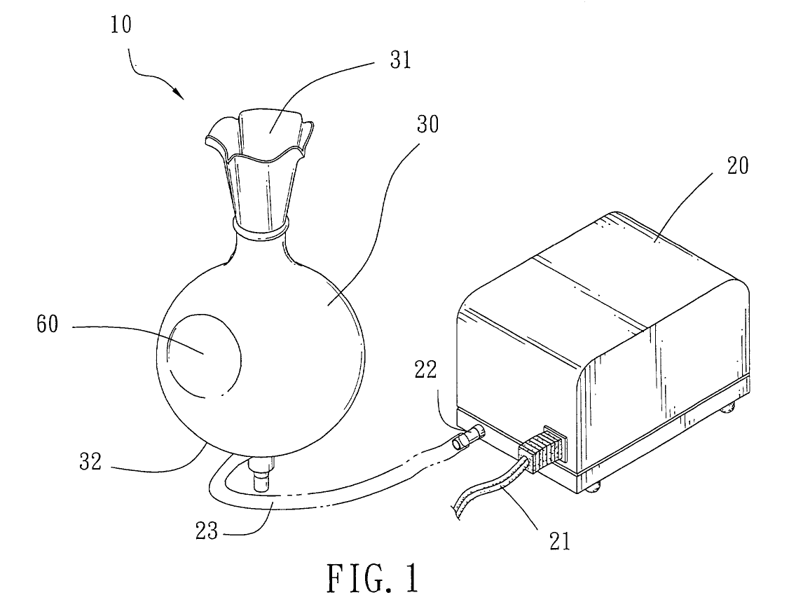

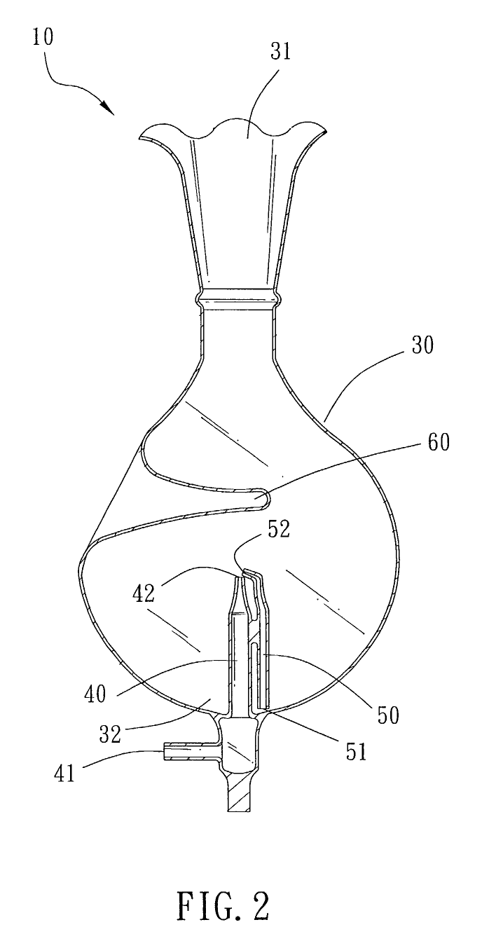

Referring to the drawings and initially to FIGS. 1 and 2, an aroma mist spraying device 10 in accordance with a first embodiment of the present invention comprises an air supply motor 20, a container 30, an air pipe 40, and an aroma supply pipe 50.

The air supply motor 20 is a rectangular structure, and is provided with a plug 21, a circular hollow air drain portion 22, and a circular hollow soft conduit 23. The plug 21 of the air supply motor 20 may be connected to a common household electric power. The gas generated in the air supply motor 20 may be drained outward from the air drain portion 22 of the air supply motor 20. The conduit 23 of the air supply motor 20 has a first end connected to the air drain portion 22 of the air supply motor 20, and a second end connected to the air pipe 40 that is connected to the container 30.

The container 30 is a transparent thin structure, and has an upper portion provided with a corrugated mouth 31, and has a lower portion provided with an aroma receiving portion 32. The container 30 has a mediate portion provided with a stop portion 60 for stopping a part of aroma, so that the aroma may be recycled and reused.

The air pipe 40 is mounted in the container 30, and has a first end extended outward from the container 30 and provided with an air inlet portion 41 that is connected to the conduit 23 of the air supply motor 20. The air pipe 40 has a second end received in the container 30 and provided with a tapered air outlet hole 42 that has a reduced diameter.

The aroma supply pipe 50 is mounted in the container 30, and has a first end extended outward from the container 30 and provided with an aroma inlet hole 51 for supplying the aroma into the aroma supply pipe 50. The aroma supply pipe 50 has a second end received in the container 30 and provided with a tapered aroma outlet hole 52 that has a reduced diameter. An included angle is defined between the aroma outlet hole 52 of the aroma supply pipe 50 and the air outlet hole 42 of the air pipe 40. Preferably, the aroma supply pipe 50 and the air pipe 40 are integrally formed with each other.

In operation, the high speed gas generated in the air supply motor 20 may be drained outward from the air drain portion 22 of the air supply motor 20 into the conduit 23 of the air supply motor 20, may then be conveyed through the air inlet portion 41 into the air pipe 40, and may then be injected outward from the air outlet hole 42 of the air pipe 40.

According to the Bernoulli's principle, when the gas injected outward from the air outlet hole 42 of the air pipe 40, the diameter of the air outlet hole 42 of the air pipe 40 is reduced, so that the flow speed at the air outlet hole 42 of the air pipe 40 is increased. Thus, the injected gas is accelerated, and is blown toward the aroma outlet hole 52 of the aroma supply pipe 50, so that the aroma outlet hole 52 of the aroma supply pipe 50 may produce a vacuum state. Thus, according to the syphon principle, the aroma contained in the aroma supply pipe 50 is pushed upward by the difference of pressure, so that the aroma may be pushed outward from the aroma outlet hole 52 of the aroma supply pipe 50. At the same time, the high speed air flow is blown from the air outlet hole 42 of the air pipe 40 toward the aroma outlet hole 52 of the aroma supply pipe 50, so that the aroma from the aroma outlet hole 52 of the aroma supply pipe 50 may produce a misting effect. The stop portion 60 of the container 30 may be used for stopping a part of the aroma, so that the aroma may be recycled and reused.

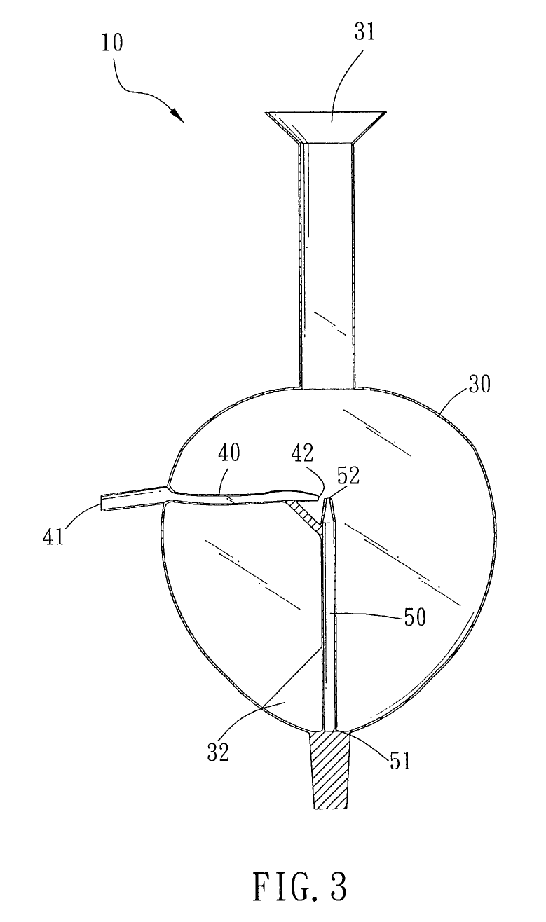

Referring to FIG. 3, in accordance with a second embodiment of the present invention, the aroma outlet hole 52 of the aroma supply pipe 50 is vertical to the air outlet hole 42 of the air pipe 40.

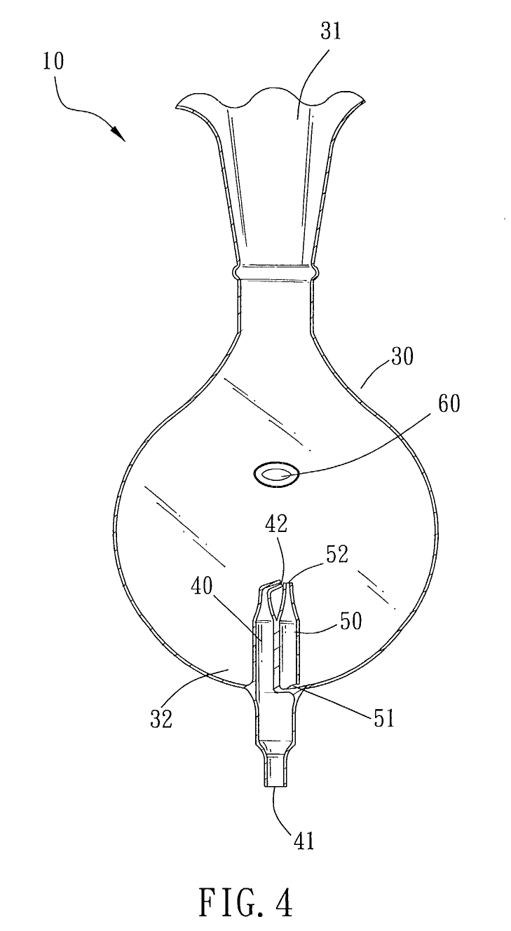

Referring to FIG. 4, in accordance with a third embodiment of the present invention, the air inlet portion 41 of the air pipe 40 is located at the lowermost position of the container 30.

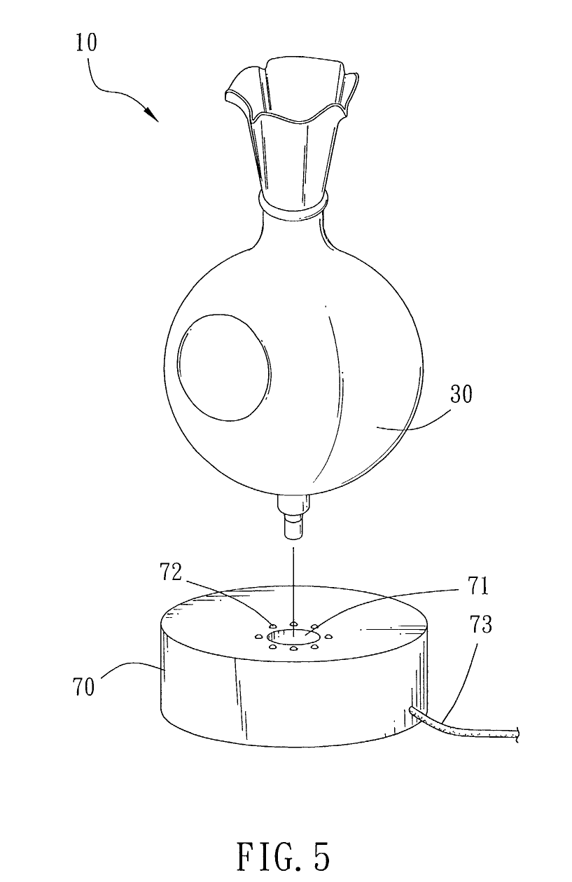

Referring to FIG. 5, in accordance with a fourth embodiment of the present invention, the aroma mist spraying device 10 further comprises a seat 70 has a central portion provided with a recessed positioning portion 71 for positioning the container 30, and provided with multiple lamps 72 arranged around the positioning portion 71. The seat 70 has a bottom provided with an electric cord 83 that may be connected to the electric power so that the aroma mist spraying device 10 may function as a night lamp that may spread the aroma.

Accordingly, the aroma mist spraying device 10 in accordance with the present invention has the following advantages.

1. The aroma mist spraying device 10 needs not to be heated or ignited, so that the aroma mist spraying device 10 may be used safely.

2. The plug 21 of the air supply motor 20 may be connected to a common household electric power, so that the aroma mist spraying device 10 may be used conveniently.

3. The stop portion 60 of the container 30 may be used for stopping a part of the aroma, so that the aroma may be recycled and reused.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. An aroma mist spraying device, comprising:
a container;
an air pipe connected to the container;
an air supply motor for supplying air through the air pipe into the container; and
an aroma supply pipe connected to the container for supplying an aroma into the container; wherein:
the aroma is pushed upward through the aroma supply pipe into the container according to a syphon principle; and
the aroma supplied from the aroma supply pipe into the container is misted by an accelerated air flow from the air pipe according to a Bernoulli's principle.

2. The aroma mist spraying device in accordance with claim 1, wherein the container has a mediate portion provided with a stop portion for stopping a part of the aroma, so that the aroma may be recycled and reused.

3. The aroma mist spraying device in accordance with claim 1, wherein the air supply motor is provided with an air drain portion, and a conduit having a first end connected to the air drain portion and a second end connected to the air pipe.

4. The aroma mist spraying device in accordance with claim 1, wherein the air supply motor is provided with a plug.

5. The aroma mist spraying device in accordance with claim 1, wherein the container has an upper portion provided with a corrugated mouth and a lower portion provided with an aroma receiving portion.

6. The aroma mist spraying device in accordance with claim 1, wherein the air pipe is mounted in the container, and has a first end extended outward from the container and provided with an air inlet portion that is connected to a conduit of the air supply motor, and has a second end received in the container and provided with a tapered air outlet hole that has a reduced diameter.

7. The aroma mist spraying device in accordance with claim 1, wherein the aroma supply pipe is mounted in the container, and has a first end extended outward from the container and provided with an aroma inlet hole for supplying the aroma into the aroma supply pipe, and has a second end received in the container and provided with a tapered aroma outlet hole that has a reduced diameter.

8. The aroma mist spraying device in accordance with claim 1, wherein the aroma supply pipe and the air pipe are integrally formed with each other.

9. The aroma mist spraying device in accordance with claim 1, wherein the aroma supply pipe has an aroma outlet hole vertical to an air outlet hole of the air pipe.

10. The aroma mist spraying device in accordance with claim 1, wherein the air pipe has an air inlet portion located at a lowermost position of the container.

11. The aroma mist spraying device in accordance with claim 1, further comprising a seat having a central portion provided with a recessed positioning portion for positioning the container, and provided with multiple lamps arranged around the positioning portion.

12. The aroma mist spraying device in accordance with claim 11, wherein the seat has a bottom provided with an electric cord.
